(19) United States
(12) Patent Application Publication
(10) Pub. No.: US 2007/0271836 A1
(43) Pub. Date: Nov. 29, 2007

(54) Slimline (Rod Holder)

(76) Inventor: Steve Carter, W. Columbia, SC (US)

Correspondence Address: Steve Carter, 900 N. Lucas St., W. Columbia, SC, 29169, US

(21) Appl. No.: 11/433,864

(22) Filed: May 15, 2006

(51) Int. Cl. A01K 97/10

(52) U.S. Cl. 43/21.2

(57) ABSTRACT

A Fishing rod holder is disclosed for supporting a fishing rod. In whatever fashion needed to allow the fisherman to troll, or to free the fisherman to do other chores, or just to relax while the rod is set and poised to catch a fish.

### SUMMARY OF THE INVENTION

The above objectives are accomplished according to the present invention by providing fishing Rod holder for supporting a fishing rod having a reel in a plurality of fishing positions comprising a support of attachment to an associated structure. The Front support is U-shaped And made of a flowing piece of round stainless steel. The front support flows in the same one piece as a bridge to the back support. The back is an upside down U-shape. The one piece flows down and around until you come to the bottom of the point that is ended with a threaded end. that screws down into and is attached to accessories on the structure to be mounted. The tips of the rod holders are covered with a high friction co-efficient tip, for protection against scratching, and protecting the actual fishing rod While also preventing breakage of the fishing line and entanglement of the line.

### FIELD OF THE INVENTION

This invention related to the supporting of fishing rods during angling. More effectively not just to provide the fisherman with a hands free support system the objective of this invention is to provide a better avenue, by which the angler may accomplish the ultimate fishing experience, with the least amount of contingency and ease in installation and usage.

### BACKGROUND OF THE INVENTION

1. Field the Invention

This invention relates to fishing and holding a rod, by means of a rod holder. Previous rod holders have often been made of plastic or substances that are not conducive to the weather and corrosion of earth elements. They also have been relatively complicated and hard to assemble. It is particularly important that removal of the rod be easily, quickly and conveniently accomplished when a fish is hooked. Eliminating problems in maneuverability of said apparatus. some of the prior devised items do not have adequate degrees of freedom of motion and thus can't be adjusted to desired positions. The object of said item is to provide novel and improved longevity and usage of said apparatus. Keeping the accessory devise simple, easy to install and weather proofed for longevity is a must. Thus the prior art has not provided a suitable fishing rod holder. Accordingly an object of the invention is to provide a fishing rod holder that cradles a fishing rod In one of the plural fishing positions. Another object of the invention is to provide a fishing rod holder, having been made out of a Non-corrosive metal. Providing this apparatus as a stainless steel holder. Another object of the present invention is to provide easy and simple installation for application of the rod holders.

another object of the invention is to provide the best possible retention in which the rod is secured in a stable fishing position yet may be released quickly to set a hook.

2. Description of the Prior Art

Fishing rod holders of various types are known in the art. Including in prior patent literature. They have typically lacked in longevity and mobility. They have been relatively complicated making it hard to remove the rod from the holder upon hooking a fish. Prior art devices have also encountered trouble in retaining the fishing rod in the holder when a degree of force is placed on the fishing rod, either from capture of fish or other forces that would drag a line and rod. With the non-symmetrical prior patents lines have experienced great entanglement, and breakage. Thus hindering the anglers fishing endeavors.

### DESCRIPTION OF THE DRAWINGS

The invention will be more readily understood from a reading of the following drawings and referencing of the drawings. That accompanies said descriptions.

FIG. 1: Illustrates a front elevation view of the fishing rod holder of the present invention FIG. 1 Depicting a picture of the actual Stainless rod holder.

FIG. 1 a: Is a drawn picture depicting the actual rod holder shown in the previous picture. FIG. 1.

FIGS. 2-5 are plural devices used for holding a multiple amount of fishing rod holders for trolling or hands free fishing of multiple lines. Fig: F 2-Fig: F 5: Is a top view plan of the holder base that is shaped as a T and can hold 4 of the standard size rod holders. Also shown FIG. 3 Which can hold 2 of the standard size rod holders. FIG. 4 and FIG. 5 differ from FIG. 2 and FIG. 3 in only that they have an angled constructed Frame instead of a straight constructed Frame. Drawings A-C. Are structures whereby the rod holders can be affixed for stability on the structure of the boat or any stationary bases. They are the developed bases that affix to the vessel Drawing A is a round base, Drawing B is a Flat base, and Drawing C is a slightly beveled, slightly raised base. Drawing D is a drawing of a Base with a rod holder through it.

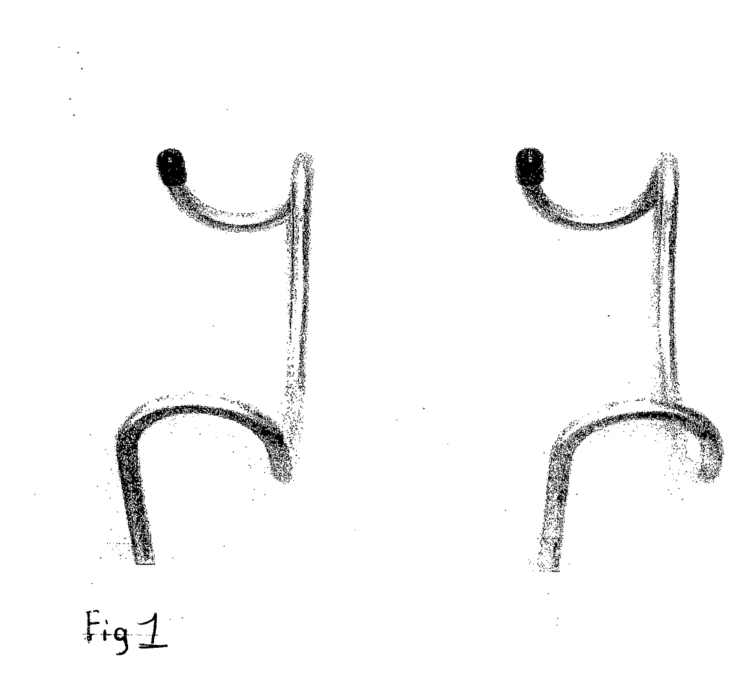

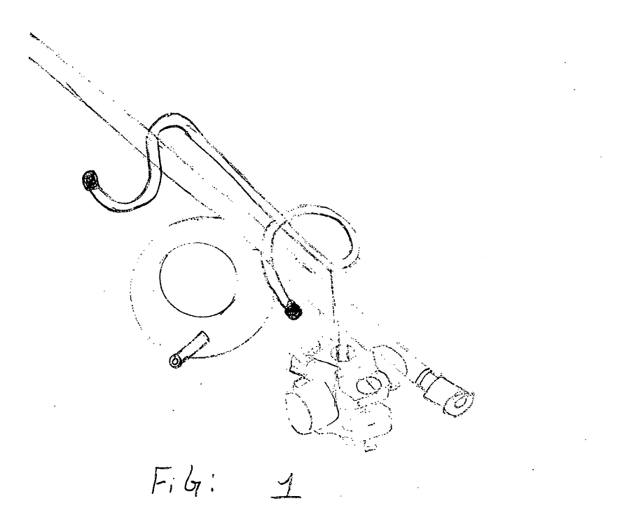

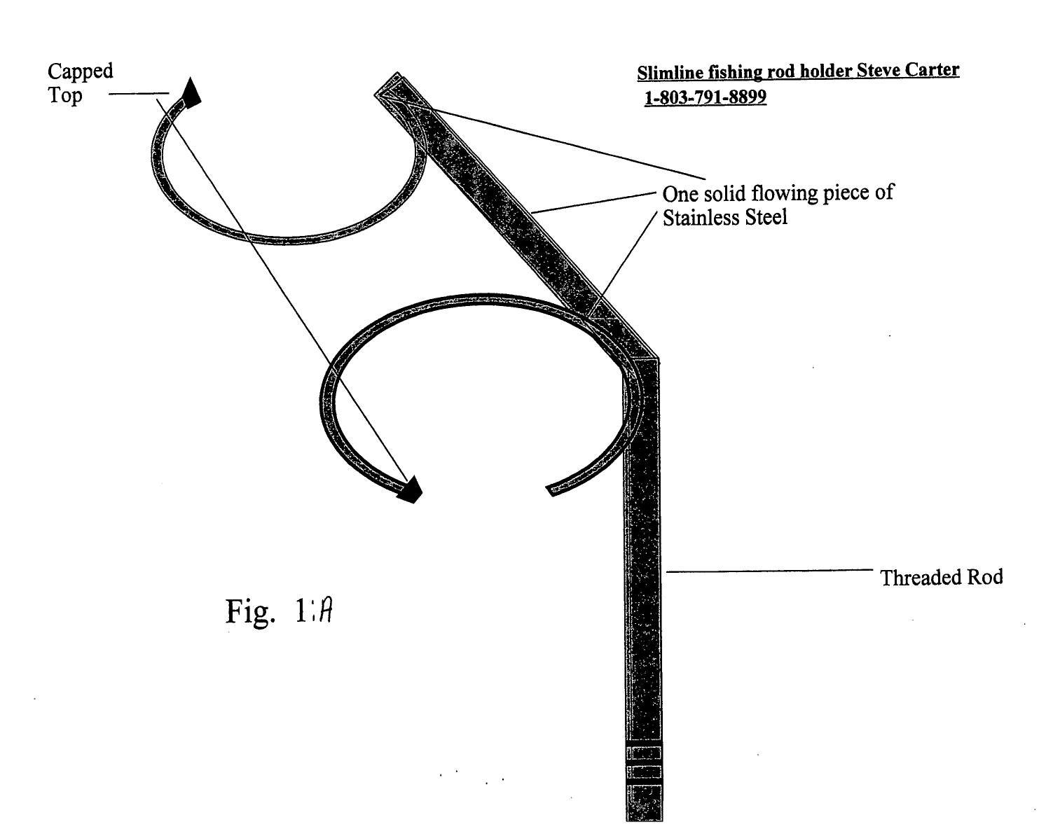

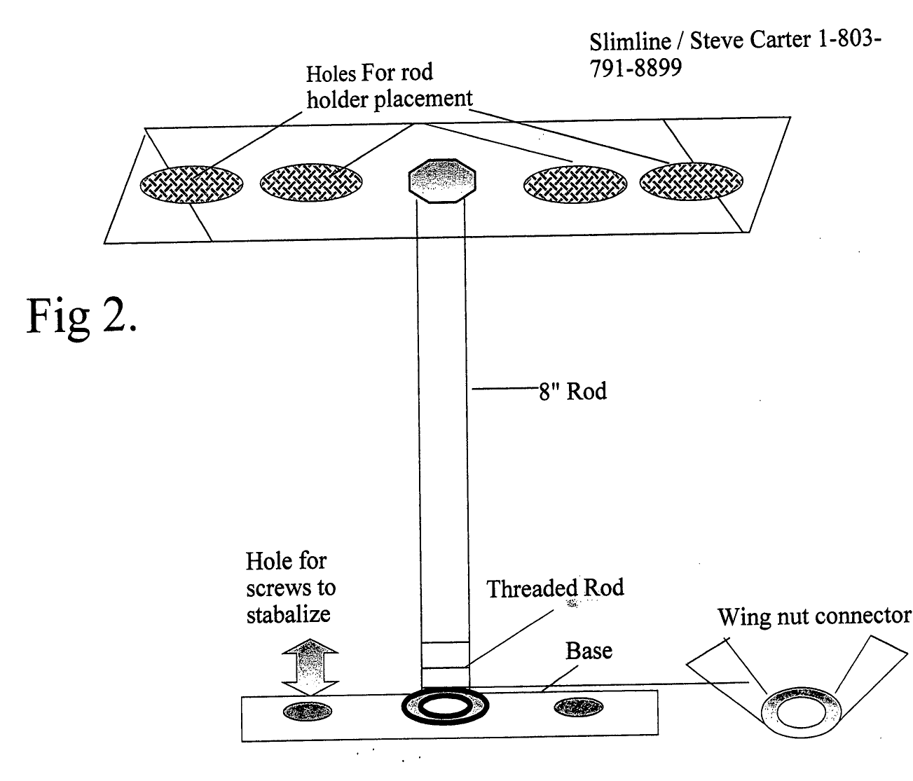

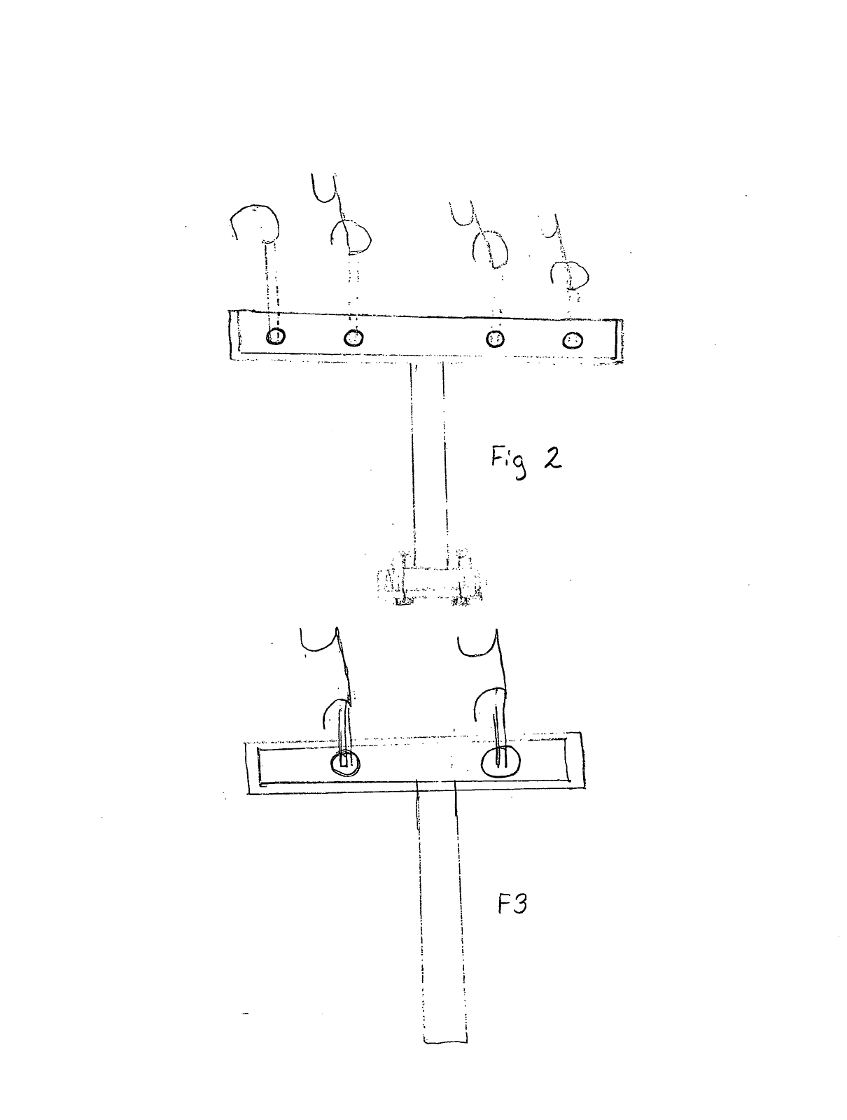

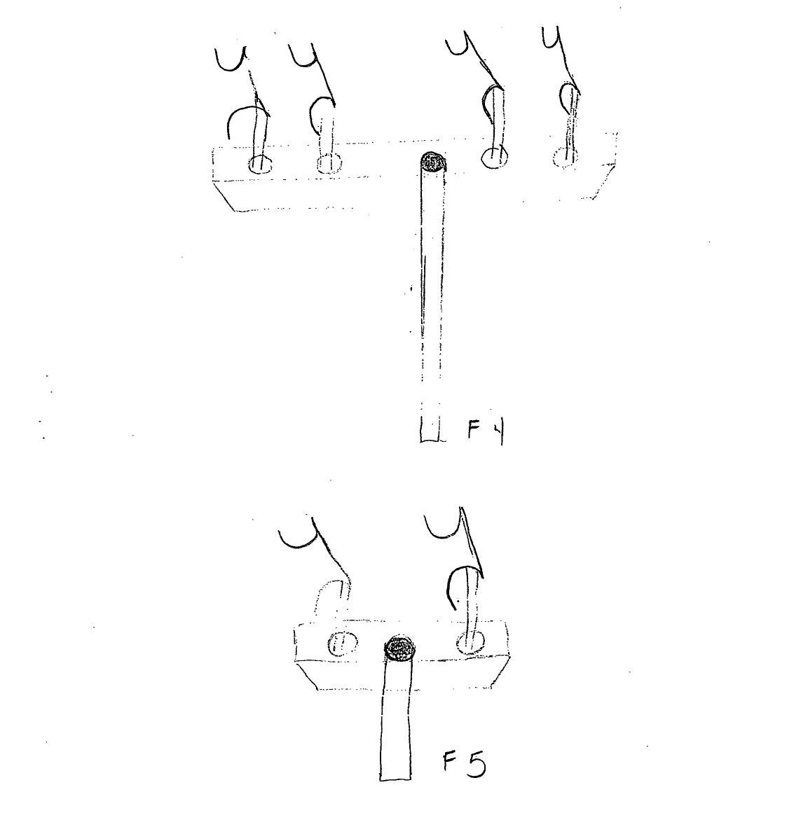

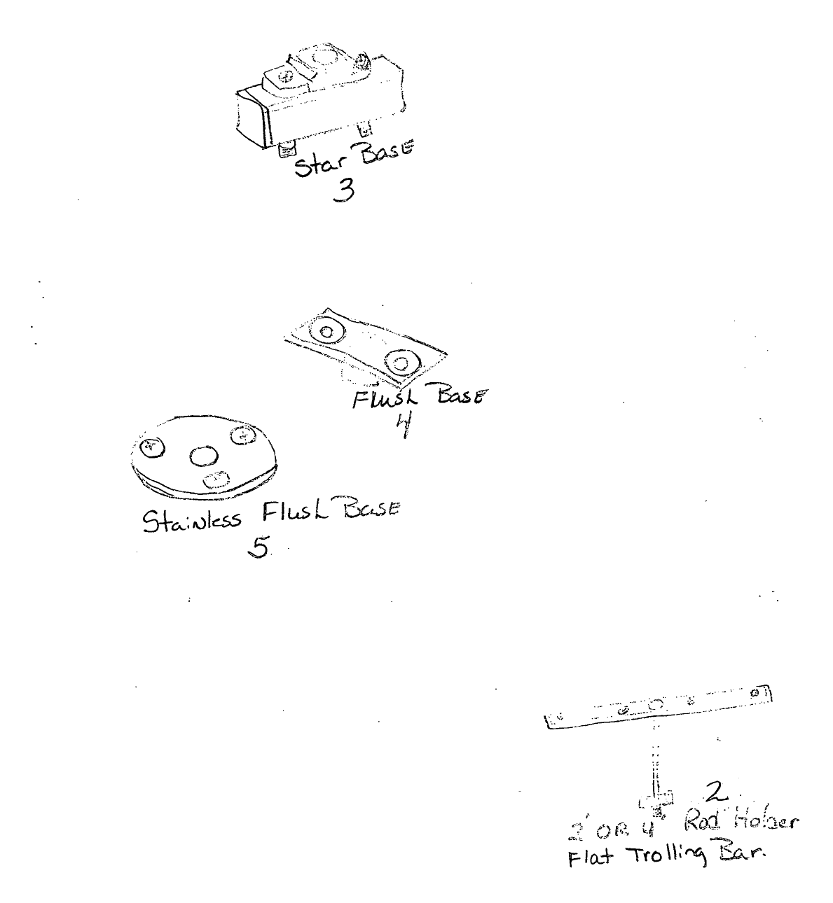

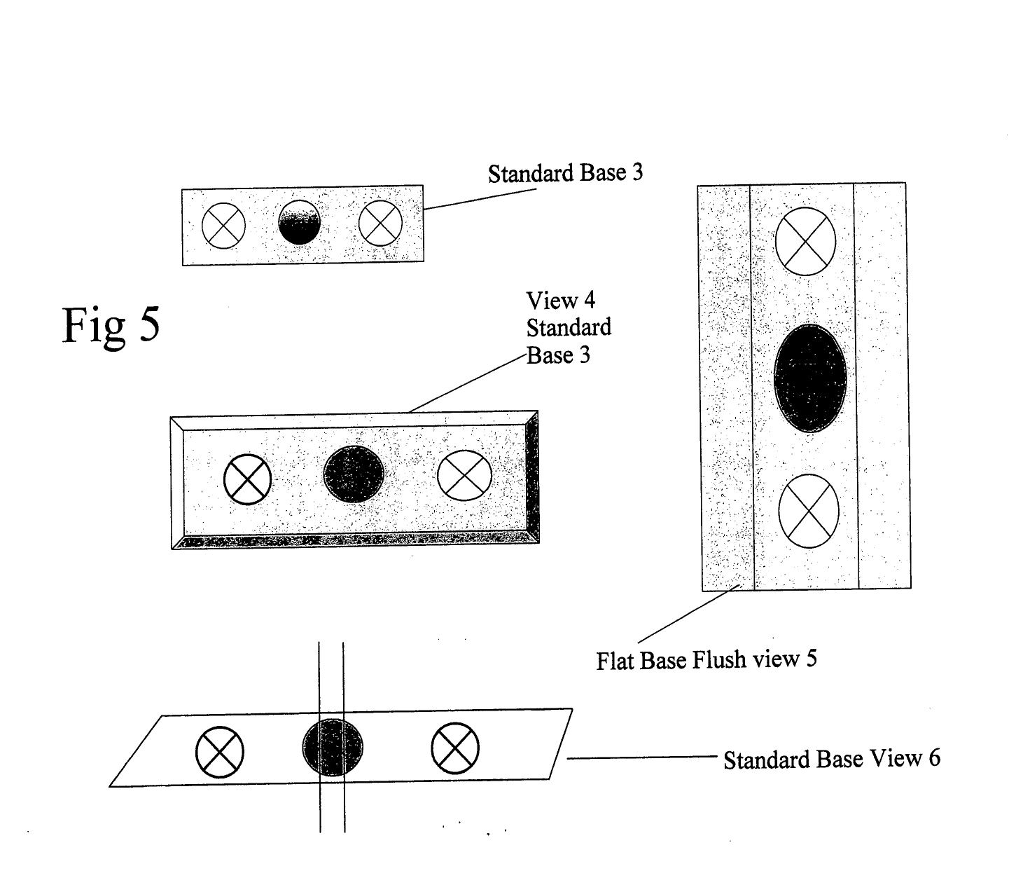

### DESCRIPTION OF THE PREFERRED EMBODIMENT

Referring now to the drawings the fishing rod holder has an added base A-C for attaching the holder to the railings of the boat or to any other stationary objects. Available also please see drawings of bases detailed description of several views these supporting objects. Whereby making this one devise more multi functional.

The holder is correctly proportioned and symmetrically designed for a perfect fit every line of the rod. Thus making it easy to lift up in an upward motion with the rod and dislodge from the holder. Furthermore any additional force that may be imposed on the fishing rod lending to pulls it downward, such as the force of a fish pulling on the hook or from the drag of the line being pulled by the boat. Thus the structure of the holder helps to prevent breakage to the line and entanglement of the line. While this description has been given for the embodiment of this invention many various modifications and substitutions may be made without circumventing the purpose of the invention. The present invention has been described by way of illustration and not by limitation.

What is claimed is:

1. A Fishing rod holder for supporting a fishing rod Comprising:
A generally U-shaped front support having a second upwardly directed arm forming a rod cradle;
A second arm merging with a downward U-shaped leg and said second shaft merging downward.
Each of said arms and legs have in sequence a downward and upward flow making the holder form a cradle for the rod.

2. The rod holder of claim 1 wherein said rod holder is a holder of a fixed shape.

3. A one piece integral fishing rod holder for supporting a fishing rod in a variety of different sizes so so that the size of the holder itself can adapt to the actual size of the rod for better angling activity. Support;

4. The holder is made of a sturdy stainless steel so that it will not rust, or corrode. the combination of claims 1-3 help the surface to remain smooth so that the rod is easy to place within the holder for ease of maneuverability.

5. The rod is a more economical and sturdy rod holder.
